(19) United States
(12) Patent Application Publication
(10) Pub. No.: US 2019/0268796 A1
(43) Pub. Date: Aug. 29, 2019

(54) POSITIONING MOVABLE ACCESS POINTS IN A WIRELESS NETWORK BASED ON SPHERE OF ERROR INFORMATION

(71) Applicant: Microsoft Technology Licensing, LLC, Redmond, WA (US)

(72) Inventor: Amer Aref HASSAN, Kirkland, WA (US)

(21) Appl. No.: 15/908,434

(22) Filed: Feb. 28, 2018

(51) Int. Cl. H04W 28/02; H04W 24/08; H04W 4/02; H04W 88/12

(52) U.S. Cl. CPC H04W 28/0226; H04W 24/08; H04W 16/18; H04W 88/12; H04W 4/023

(57) ABSTRACT

A method for managing variable traffic load in a wireless network includes determining relative location information corresponding to user devices and at least one movable access point in the wireless network. Sphere of error information corresponding to the user devices may also be determined. The method also includes determining, based at least in part on the relative location information and the sphere of error information, that the at least one movable access point should be repositioned to achieve a desired outcome. The method also includes causing the at least one movable access point to be repositioned.

### CROSS-REFERENCE TO RELATED APPLICATIONS

N/A

### BACKGROUND

A wireless network is a computer network that uses wireless data connections between network nodes. There are many different types of wireless networks in use today. Some examples include wireless local area networks (WLANs) and cellular networks.

A WLAN is typically deployed within a relatively limited geographic area (e.g., a home, school, computer laboratory, office building). WLANs give users the ability to move around within a local coverage area and yet still be connected to the network. A typical WLAN includes one or more access points (APs). An AP may be connected directly to a wired local area network (LAN) and may provide wireless connections for other devices to use that wired connection. An AP typically supports the connection of multiple wireless devices through its single wired connection. Most WLANs in use today are based on the Institute of Electrical and Electronics Engineers (IEEE) 802.11 standards.

Cellular networks generally provide coverage over a wide geographic area. A typical cellular network includes a large number of overlapping geographic areas, or cells, each of which is served by one or more base stations. Mobile devices connect to a cellular network via a radio link to a base station. Base stations are connected to a core network, which facilitates circuit-switched voice communications between mobile devices and with telephones in the wider public switched telephone network (PSTN). Base stations are also connected to a packet switched network, which enables data packets to be sent to and received from external networks such as the Internet. Major telecommunications providers have deployed voice and data cellular networks in many areas throughout the world.

### BRIEF DESCRIPTION OF THE DRAWINGS

In order to describe the manner in which features of the disclosure can be obtained, a description will be rendered by reference to specific embodiments thereof which are illustrated in the appended drawings. For better understanding, similar reference numbers have been used for similar features in the various embodiments. Unless indicated otherwise, these similar features may have the same or similar attributes and serve the same or similar functions. Understanding that the drawings depict some examples of embodiments, the embodiments will be described and explained through the use of the accompanying drawings in which:

FIGS. 1A-D illustrate an example of a wireless network in which a single movable access point is positioned based on sphere of error information.

FIG. 2 illustrates an example of a wireless network in which multiple movable access points are positioned based on sphere of error information.

FIG. 3 illustrates an example of a wireless network in which a network controller is used to position movable access points in a wireless network.

FIG. 4 illustrates an example of a wireless network in which multiple network controllers are used to position movable access points in a wireless network.

FIG. 5 illustrates an example of a method for managing variable traffic load in a wireless network.

FIG. 6 illustrates certain components that may be included in a movable access point.

FIG. 7 illustrates certain components that may be included in a user device.

FIG. 8 illustrates certain components that may be included in a network controller.

### DETAILED DESCRIPTION

A wireless network may include one or more access points (APs) that enable user devices (e.g., smartphones, tablet computers, laptop computers) to connect to the network. The techniques disclosed herein are applicable to many different types of wireless networks, including WLANs and cellular networks. Thus, the term “access point” (or “AP”), as used herein, should be interpreted broadly to encompass any networking hardware device that allows one or more user devices to connect to a network via wireless communications, including both WLAN APs (such as those that operate in accordance with an IEEE 802.11 standard) as well as cellular network base stations.

APs may be required to support large amounts of traffic over coverage areas that are relatively large and have amorphous boundaries. There may be a variable traffic load, such that the number of users and devices that need to be supported and the requirements of those users and devices may be unpredictable and vary drastically over time, and the traffic load may shift quickly from one individual AP to another. Compounding the difficulties in providing good coverage in these situations is the fact that it is typically desirable to minimize the number of APs that are used in a wireless network in order to keep the cost of the network down.

Movable APs may be utilized to address some of these challenges. As used herein, the term “movable AP” refers to an AP that is capable of repositioning itself. For example, a movable AP may be capable of transporting itself from one location to another. In some embodiments, a movable AP may include an AP that is mounted or otherwise attached to a vehicle. The vehicle may enable the AP to be able to transport itself from one location to another. The vehicle may be a ground vehicle (e.g., a wheel-based robot) or an aerial vehicle (e.g., a drone). The vehicle may be unmanned. In some embodiments, in addition to (or instead of) being able to transport itself to a new location, a movable AP may also be capable of reorienting itself (e.g., reorienting one or more of its antennas).

One benefit of having movable APs within a wireless network is that they may be repositioned as the traffic load within the network changes over time. It can, however, be challenging to know where the APs should be located and how they should be oriented in order to manage the variable traffic load in a wireless network.

In accordance with the present disclosure, information about the sphere of error corresponding to user devices within a network may be utilized to determine where and how the movable APs should be positioned and oriented. As used herein, the term “sphere of error” refers to an indication of how many errors are being corrected by a wireless receiver at a given point in time. The sphere of error is not the same as an error rate, which is an average over time. Instead, the sphere of error for a particular receiver is a real-time indication of the number of errors that are being corrected by that receiver at that point in time. The sphere of error may provide an instantaneous indication of the number of errors that were corrected by a receiver in a most recent decoding cycle. Some examples showing how the sphere of error may be determined will be discussed below.

In accordance with the present disclosure, movable APs may be repositioned (e.g., transported from one location to another and/or reoriented) in order to achieve a variety of desired outcomes. For example, one or more movable APs may be repositioned to equalize, to the extent possible, the sphere of error across user devices in the network. Alternatively, one or more movable APs may be repositioned to give some user devices more favorable treatment than others (e.g., so that high priority user devices have a small sphere of error, while lower priority user devices have a large sphere of error). As yet another example, one or more movable APs may be repositioned to give certain applications more favorable treatment than others.

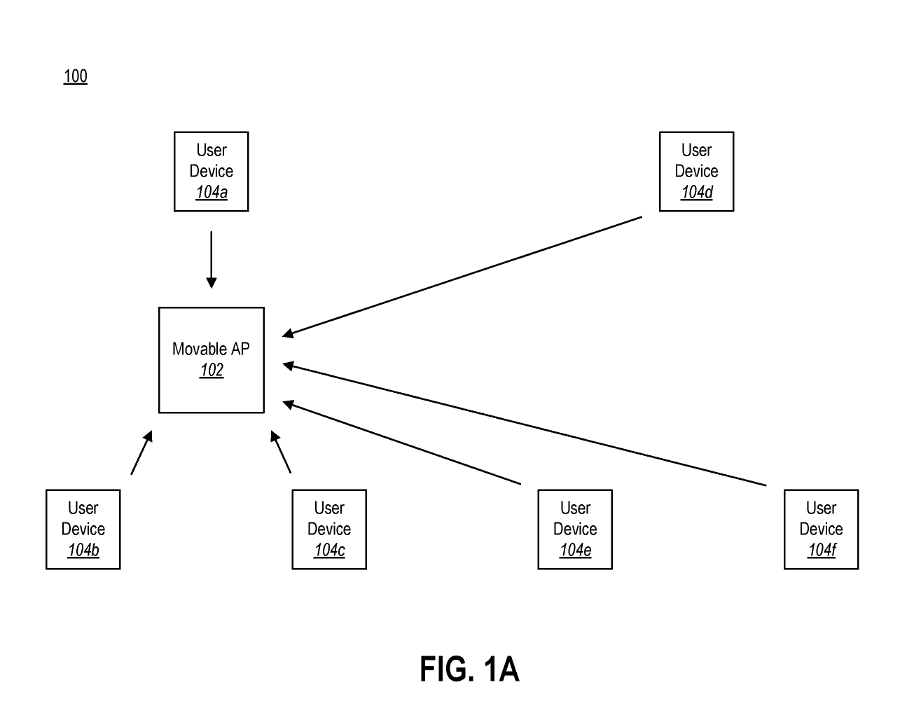

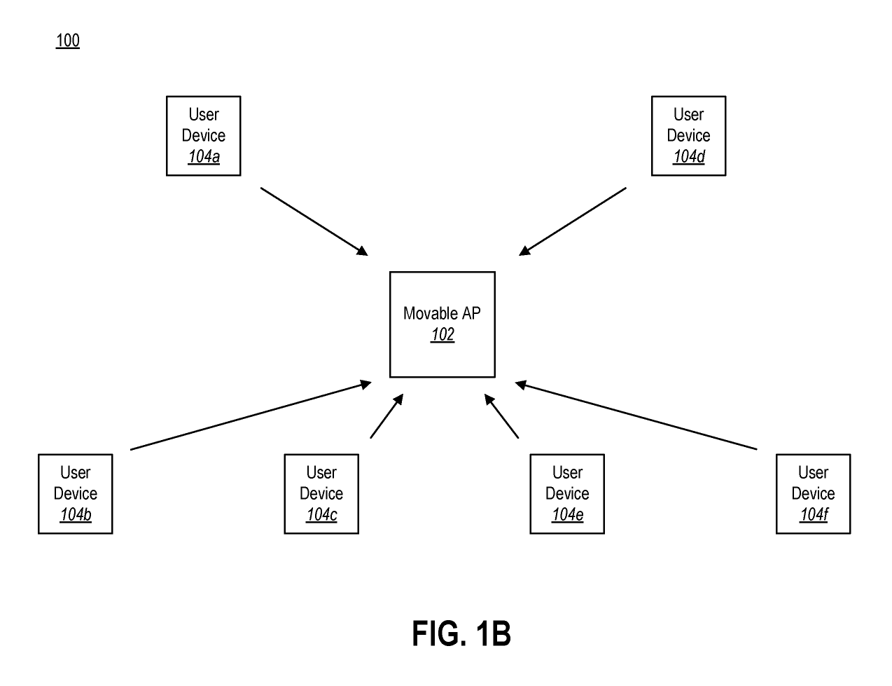

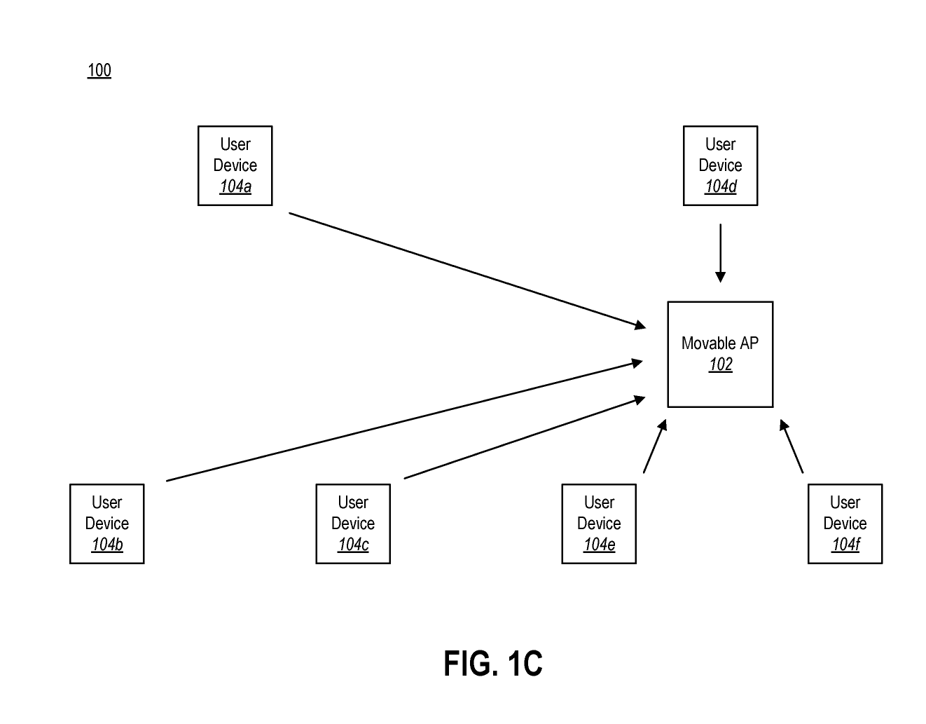

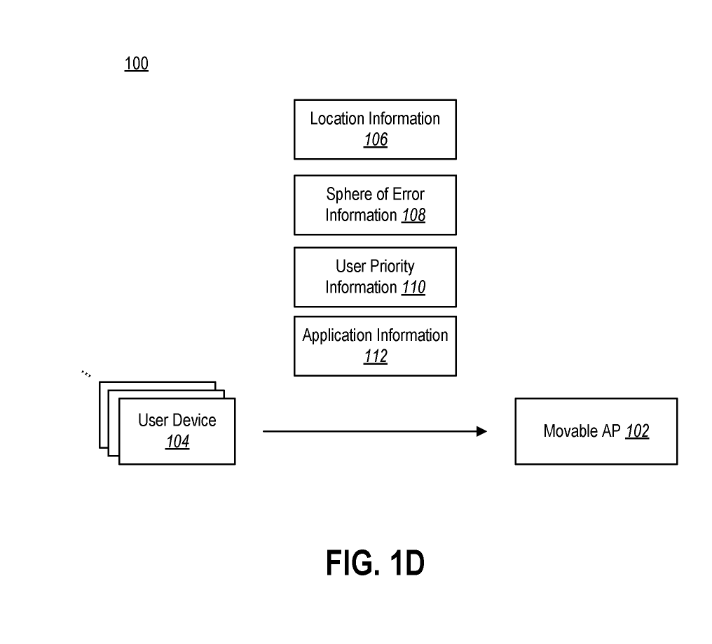

An example will be discussed in relation to FIGS. 1A-D, which show a network 100 that includes a single movable AP 102. The movable AP 102 is in electronic communication with a plurality of user devices 104a-f. The movable AP 102 enables the user devices 104a-f to connect to the network 100. FIG. 1A shows the network 100 at a point in time when the movable AP 102 is located relatively close to some of the user devices 104a-c in the network 100, and relatively far away from other user devices 104d-f in the network 100. At the point in time illustrated in FIG. 1A, the user devices 104a-c that are located relatively close to the movable AP 102 may have a relatively small sphere of error. On the other hand, the user devices 104d-f that are located relatively far away from the movable AP 102 may have a relatively large sphere of error. In other words, the receivers in the user devices 104a-c that are located relatively close to the movable AP 102 may be correcting a relatively small number of errors, while the receivers in other user devices 104d-f that are located relatively far away from the movable AP 102 may be correcting a relatively large number of errors.

Each user device 104 may be configured to communicate certain information to the movable AP 102 that enables the movable AP 102 to determine where and how it should be positioned in order to achieve a particular desired outcome. For example, each user device 104 may be configured to determine information such as its location and its sphere of error, and to communicate location information 106 and sphere of error information 108 to the movable AP 102, as shown in FIG. 1D. The location information 106 may be information about the relative location of one or more of the user devices 104a-f relative to the movable AP 102.

The movable AP 102 may be configured to evaluate the location information 106 and the sphere of error information 108 that it receives from the user devices 104. Based on its evaluation of this information (and possibly other information as well, as will be discussed below), the movable AP 102 may determine where and how it should be positioned in order to achieve a desired outcome. Under some circumstances, the movable AP 102 may determine that it should be repositioned to a new location. For example, suppose that the desired outcome is to equalize, to the extent possible, the sphere of error across all user devices 104. In the location shown in FIG. 1A, some of the user devices 104a-c may have a relatively small sphere of error, while other user devices 104d-f may have a relatively large sphere of error. In this case, the movable AP 102 may determine that it should reposition itself to a new location where the movable AP 102 is, as much as possible, equidistant from the user devices 104a-f, as shown in FIG. 1B. Repositioning the movable AP 102 to this new location may have the effect of decreasing the sphere of error of some of the user devices 104d-f and increasing the sphere of error of some of the other user devices 104a-c.

Other types of desired outcomes are also possible. For example, suppose that some of the user devices 104d-f in the network 100 are higher priority than other user devices 104a-c. In this case, the desired outcome may be to minimize the sphere of error for the high priority user devices 104d-f, even if that adversely affects the lower priority user devices 104a-c. To achieve this desired outcome, the movable AP 102 may determine that it should reposition itself to the location that is shown in FIG. 1C, where the movable AP 102 is positioned relatively close to the high priority user devices 104d-f.

In some embodiments, a desired outcome may include some combination of equalization and priority. For example, one possible desired outcome may be to keep the sphere of error for high priority user devices 104d-f below a certain threshold, but otherwise to equalize the sphere of error across user devices 104. In this case, the movable AP 102 may be positioned somewhere between the location shown in FIG. 1B (which attempts to equalize the sphere of error across user devices 104) and the location shown in FIG. 1C (which attempts to give user devices 104d-f the best possible performance).

There are a variety of possible reasons why some user devices 104d-f may have higher priority than others. In some embodiments, priority could be determined based at least in part on relative priorities of users. For example, suppose that the network 100 is a corporation's WLAN, and that the user devices 104 belong to various employees of the corporation. In this example, user devices 104d-f belonging to certain types of employees (e.g., corporate executives) may be considered to have higher priority than user devices 104a-c belonging to other types of employees.

In other embodiments, priority could be determined based at least in part on application requirements, such as quality of service (QoS) requirements. For example, if some user devices 104d-f are using an application that requires a low-latency Internet connection (e.g., a videoconferencing application), then these user devices 104d-f may be considered to have higher priority than other user devices 104a-c that are not using such an application and therefore do not have such high QoS requirements.

Thus, as shown in FIG. 1D, the movable AP 102 may take into consideration other information, in addition to location information 106 and sphere of error information 108, when determining where and how the movable AP 102 should be positioned. For example, if the position of the movable AP 102 is based at least in part on priority of the user devices 104, then the movable AP 102 may take user priority information 110 into consideration. The user priority information 110 may indicate the relative priority of user devices 104. For example, the user priority information 110 may indicate one or more user devices 104 that should receive favorable treatment (e.g., by minimizing the sphere of error). If the position of the movable AP 102 is based at least in part on application requirements, then the movable AP 102 may take application information 112 into consideration. The application information 112 may indicate the relative priority of applications running on user devices 104. For example, the application information 112 may indicate one or more applications that should receive favorable treatment (e.g., by minimizing the sphere of error for user devices 104 that are running those applications). In some embodiments, user priority information 110 and application information 112 may be received from the user devices 104. Alternatively, user priority information 110 and/or application information 112 may be received from other sources (e.g., a network administrator).

Some examples showing how the sphere of error may be determined will now be discussed. Suppose that a signal is wirelessly transmitted from a transmitting device (e.g., a movable AP 102) to a receiving device (e.g., a user device 104). The signal may be received by an antenna at the user device 104, downsampled, and quantized into a sequence of bits. These bits may then be input to a demodulator, which may be configured to estimate the coded bits that were transmitted. The output of the demodulator may then be provided to a forward error correction (FEC) decoder (which may simply be referred to as a decoder herein). The decoder may be configured to perform at least two functions: (1) locate the errors due to transmission over a channel, (2) estimate the value of the error for each location.

If the estimate of the coded bits that were transmitted only includes binary bits, then finding the location of the errors (i.e., function (1) above) may be sufficient because the value of the error may always be the bit 1. In this case, the sphere of error may include all error patterns such that the Hamming weight (in other words the number of errors) is less than or equal to a provisioned number E. If the Hamming weight (or radius) is greater than or equal to E, then one or more movable APs 102 may be repositioned to achieve a desired outcome (e.g., equalizing errors across the network 100, or giving some user devices 104 more favorable treatment than others), as discussed above.

In the example that was just described, the Hamming weight was used as the radius of a sphere with binary vectors. Alternatively, the symbols can be nonbinary and could also be soft numbers. For example, instead of a 0 and a 1, the input to the decoder could be −0.99 and 2.2. A Euclidean distance could be used for soft values.

Thus, in some embodiments, the sphere of error information 108 for a particular user device 104 may simply include the number of errors that a receiver within the user device 104 has corrected in the most recent decoding cycle. Alternatively, in some other embodiments, the sphere of error information 108 for a particular user device 104 may include a metric that is determined based on the number of errors that a receiver within the user device 104 has corrected in the most recent decoding cycle and an estimated value of those errors.

In some embodiments, the sphere of error may be determined using a Hamming distance as the radius of the sphere of error. Alternatively, in other embodiments, the sphere of error may be determined using a Euclidean distance as the radius of the sphere of error.

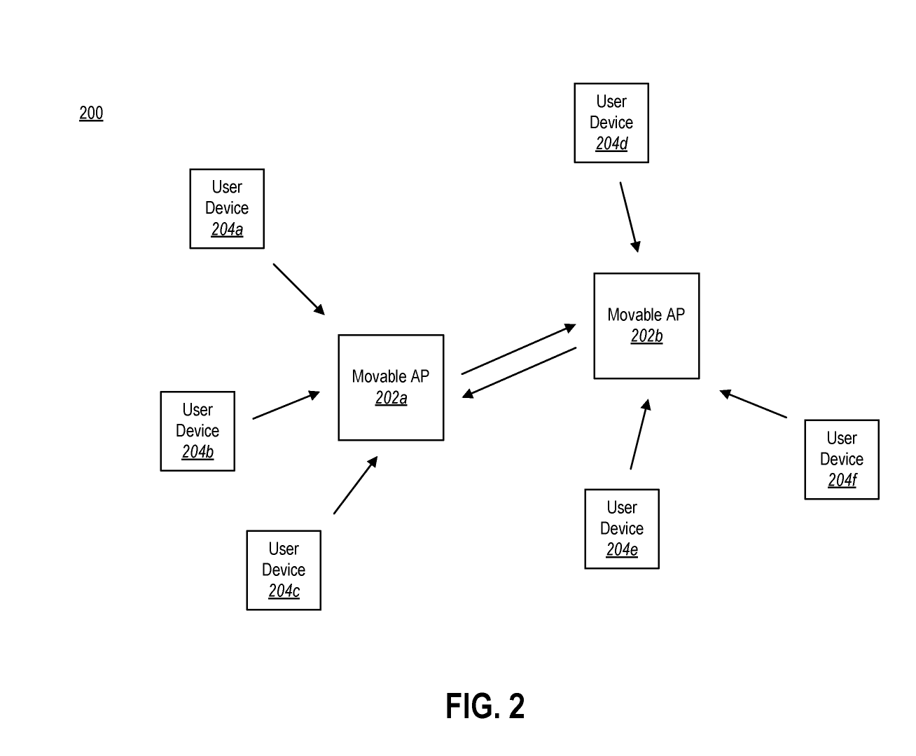

FIG. 2 illustrates an example of a network 200 that includes two movable APs 202a-b. The movable APs 202a-b may communicate with each other and with the user devices 204a-f to determine where the movable APs 202a-b should be positioned in order to achieve a desired outcome.

User devices 204a-c that access the network 200 through a first movable AP 202a may report location information 106 and sphere of error information 108 to the first movable AP 202a, and user devices 204d-f that access the network 200 through a second movable AP 202b may report location information 106 and sphere of error information 108 to the second movable AP 202b. The location information 106 may be information about the relative location of one or more of the user devices 204a-f relative to one or both of the movable APs 202a-b.

In some embodiments, the movable APs 202a-b may work together to control their positioning within the network 200. The movable APs 202a-b may exchange location information 106 and sphere of error information 108 with each other. For example, the first movable AP 202a may report the information that it receives from user devices 204a-c to the second movable AP 202b, and vice versa. Each movable AP 202a-b may be configured to determine where it should be positioned based on the information that it receives from the user devices 204a-f and from the other movable AP 202a-b.

Alternatively, in other embodiments, one movable AP 202a may be selected to control the positioning of all of the movable APs 202a-b within the network 200. The movable AP 202a that is selected to perform this role may be referred to herein as a primary movable AP 202a. The primary movable AP 202a may receive location information 106 and sphere of error information 108 directly from some of the user devices 204a-c, and indirectly from some of the other user devices 204d-f via the other movable AP 202b. Depending on what type of outcome is desired, the primary movable AP 202a may also take into consideration other information as well (such as user priority information 110 and application information 112). The primary movable AP 202a may reposition itself based on its evaluation of the information that it receives. If the primary movable AP 202a determines that the other movable AP 202b should be repositioned, the primary movable AP 202a may send instructions to the other movable AP 202b indicating what type of repositioning should occur.

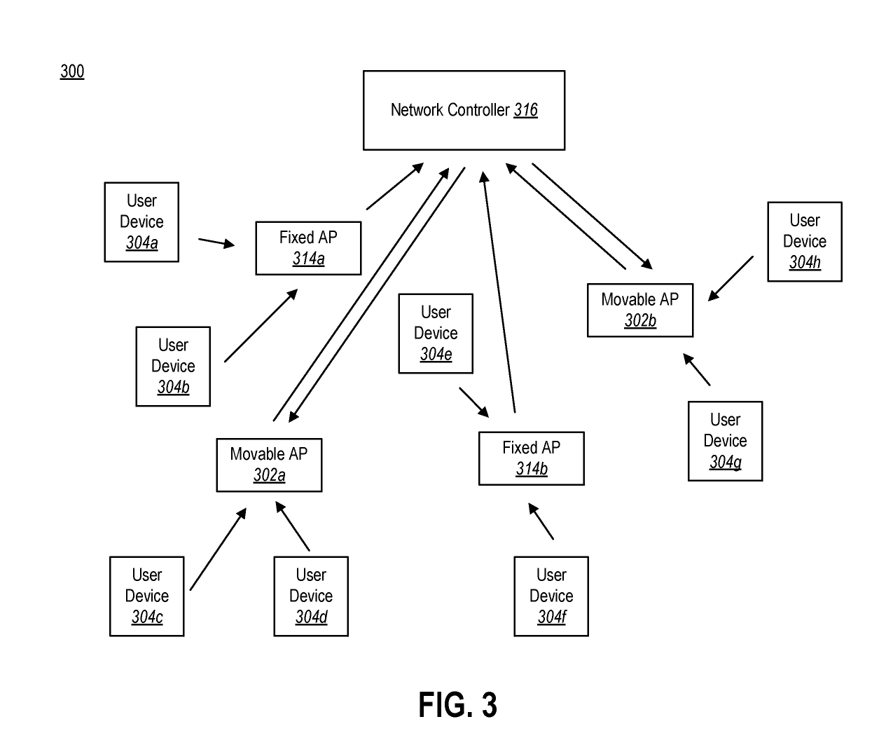

FIG. 3 illustrates an example of a network 300 that includes fixed APs 314a-b as well as movable APs 302a-b and user devices 304a-h. As used herein, the term “fixed AP” refers to an AP that is not capable of repositioning itself. Thus, the fixed APs 314a-b may not be capable of transporting themselves from one location to another or reorienting themselves.

The network 300 also includes a controller 316. In this embodiment, instead of having one or more of the movable APs 302a-b control how the movable APs 302a-b are positioned, the controller 316 may be configured to control the positioning of the movable APs 302a-b within the network 300.

Each user device 304a-h may communicate location information 106 and sphere of error information 108 to one of the APs 302a-b, 314a-b. The APs 302a-b, 314a-b may forward this information to the controller 316. Each movable AP 302a-b may also report location information 106 to the controller 316. In some embodiments, the controller 316 may know where the fixed APs 314a-b are located within the network 300. Alternatively, the fixed APs 314a-b may also report location information 106 to the controller 316. The location information 106 may be information about the relative location of one or more of the user devices 304a-h relative to one or both of the movable APs 302a-b and/or the fixed APs 314a-b.

The controller 316 may be configured to evaluate the information that it receives and to determine how the movable APs 302a-b should be positioned in order to achieve a desired outcome. Depending on what type of outcome is desired, the controller 316 may also take into consideration other information as well (such as user priority information 110 and application information 112). If the controller 316 determines that one or more of the movable APs 302a-b should be repositioned, the controller 316 may send instructions to the movable APs 302a-b indicating what type of repositioning should occur.

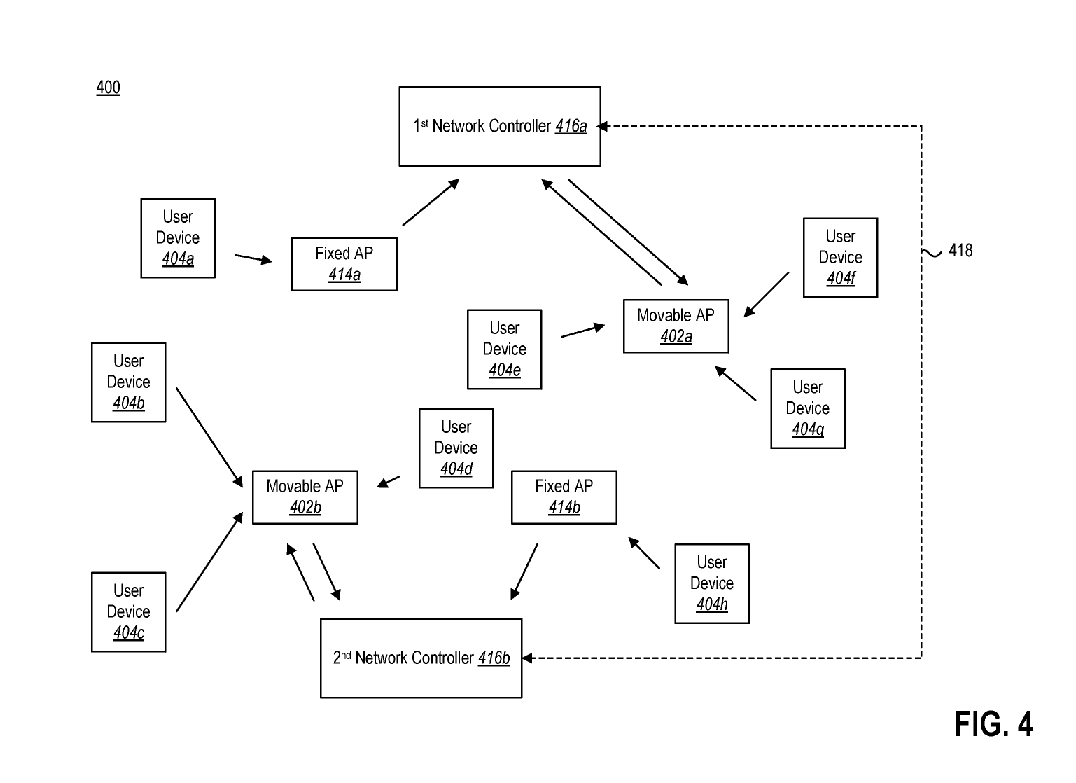

FIG. 4 illustrates an example of a network 400 that includes movable APs 402a-b, fixed APs 414a-b, user devices 404a-h, and multiple controllers 416a-b. Each user device 404a-h may communicate location information 106 and sphere of error information 108 to one of the APs 402a-b, 414a-b. The APs 402a-b, 414a-b may forward this information to one of the controllers 416a-b. Each movable AP 402a-b may also report location information 106 to one of the controllers 416a-b. The location information 106 may be information about the relative location of one or more of the user devices 404a-h relative to one or both of the movable APs 402a-b and/or the fixed APs 414a-b and/or the controllers 416a-b.

The controllers 416a-b may work together to evaluate the location information 106 and sphere of error information 108 (and possibly other information as well, such as user priority information 110 and application information 112) and determine how the movable APs 402a-b within the network 400 should be positioned in order to achieve a desired outcome. The controllers 416a-b may exchange information with each other. For example, the first controller 416a may report at least some of the information that it receives from APs 402a, 414a to the second controller 416b, and vice versa. Communication between the controllers 416a-b may occur via a backhaul connection 418. If a determination is made that one or both of the movable APs 402a-b should be repositioned, one or both controllers 416a-b may send instructions to the movable APs 402a-b indicating what type of repositioning should occur.

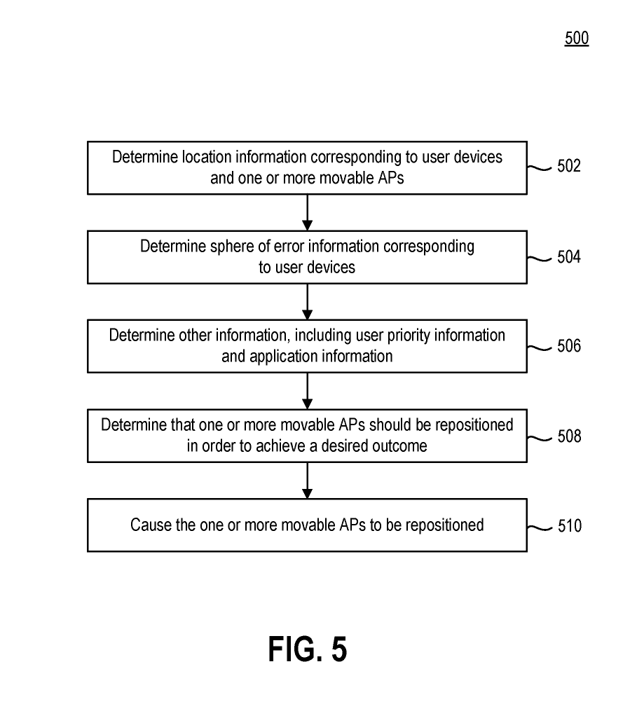

FIG. 5 illustrates an example of a method 500 for managing variable traffic load in a wireless network 400 in accordance with the present disclosure. The method 500 will be discussed in relation to the network 400 shown in FIG. 4. In some embodiments, the method 500 may be performed by one or more movable APs 402a-b. In other embodiments, the method 500 may be performed by one or more controllers 416a-b.

The method 500 may include determining 502 location information 106 corresponding to user devices 404a-h and one or more movable access points 402a-b in a network 400, and determining 504 sphere of error information 108 corresponding to the user devices 404a-h. Other information, including user priority information 110 and application information 112, may also be determined 506.

If the method 500 is being performed by a movable AP 402a-b, at least some of the location information 106, sphere of error information 108, and other information may be received directly from user devices 404a-h. In a network 400 that includes multiple movable APs 402a-b, at least some of the location information 106, sphere of error information 108, and other information may be received from one or more other movable APs 402a-b in the network 400. If the method 500 is being performed by a network controller 416a-b, the location information 106, sphere of error information 108, and other information may be received from APs (including movable APs 402a-b and/or fixed APs 414a-b).

The method 500 may also include determining 508, based at least in part on the location information 106 and the sphere of error information 108 (and possibly other information as well), that one or more movable APs 402a-b should be repositioned in order to achieve a desired outcome. As discussed above, a variety of desired outcomes are possible. If the desired outcome is to equalize (to the extent possible) the sphere of error across all user devices 404a-h, then the location information 106 and the sphere of error information 108 may be used to determine whether and how the movable AP(s) 402a-b should be repositioned. If the desired outcome is to provide some high priority user devices 404a-h more favorable treatment than other user devices 404a-h, then user priority information 110 may additionally be used to determine whether and how the movable AP(s) 402a-b should be repositioned. If the desired outcome is to provide certain applications (e.g., those with high QoS requirements) more favorable treatment than other applications, then application information 112 may additionally be used to determine whether and how the movable AP(s) 402a-b should be repositioned.

Determining 508 that one or more movable APs 402a-b should be repositioned may be based at least in part on determining that the sphere of error for one or more user devices 404a-h exceeds a defined threshold. In some embodiments, determining 508 that one or more movable APs 402a-b should be repositioned may be based at least in part on determining that the sphere of error for one or more user devices 404a-h has exceeded a defined threshold for a certain period of time (e.g., for N decoding cycles, where N is a defined integer value).

The method 500 may also include causing 510 one or more movable APs 402a-b to be repositioned. As discussed above, repositioning a movable AP 402a-b may involve transporting the movable AP 402a-b from one location to another, and/or reorienting the movable AP 402a-b (e.g., reorienting one or more of its antennas). In some embodiments, causing 510 the movable AP(s) 402a-b to be repositioned may involve sending instructions to one or more movable APs 402a-b indicating what type of repositioning should occur.

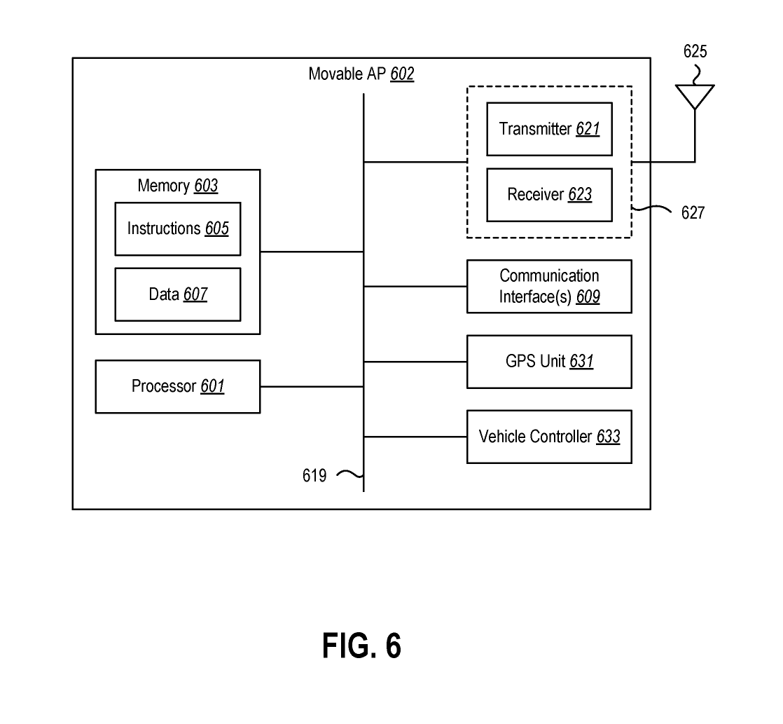

FIG. 6 illustrates certain components that may be included in a movable AP 602. Any of the movable APs 102, 202a-b, 302a-b, 402a-b described herein may be implemented with some or all of the components shown in the movable AP 602.

The movable AP 602 includes a processor 601. The processor 601 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the movable AP 602 of FIG. 6, in an alternative configuration, a combination of processors (e.g., an ARM and DSP) could be used.

The movable AP 602 also includes memory 603. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality that has been described herein with respect to the movable APs 102, 202a-b, 302a-b, 402a-b. For example, the instructions 605 may be executable by the processor 601 to perform some or all of the operations described above in connection with the method 500 shown in FIG. 5. Any of the various examples of modules and components described herein may be implemented, partially or wholly, as instructions 605 stored in memory 603 and executed by the processor 601.

Executing the instructions 605 may involve the use of the data 607 that is stored in the memory 603. Any of the various examples of data described herein may be among the data 607 that is stored in memory 603 and used during execution of the instructions 605 by the processor 601. Some examples of data 607 that may be stored in the memory 603 and used in connection with executing the instructions 605 include location information 106, sphere of error information 108, a threshold for an acceptable sphere of error, user priority information 110, application information 112, information describing one or more desired outcomes for a network, and repositioning instructions (which may, for example, be sent to another movable AP).

The movable AP 602 may also include a transmitter 621 and a receiver 623 to facilitate wireless transmission and reception of signals to and from the movable AP 602 via an antenna 625. The transmitter 621 and receiver 623 may be collectively referred to as a transceiver 627. The transceiver 627 may enable the movable AP 602 to receive information (e.g., location information 106, sphere of error information 108) from user devices 104. In some embodiments, the movable AP 602 may include (not shown) multiple transmitters, multiple antennas, multiple receivers and/or multiple transceivers.

The movable AP 602 may also include one or more other communication interfaces 609, at least some of which may be based on wired communication technology. For example, the one or more other communication interfaces 609 may include a Universal Serial Bus (USB) and/or an Ethernet adapter. The movable AP 602 may use the communication interface(s) 609 to communicate with other devices (such as another movable AP or a network controller). For example, the communication interface(s) 609 may facilitate communication with a network controller over a backhaul connection (such as the backhaul connection 418 shown in FIG. 4).

The movable AP 602 may also include a global positioning system (GPS) unit 631 that is configured to determine information about the current location of the movable AP 602. The GPS unit 631 may include a GPS receiver. The location information 106 discussed previously may include information provided by the GPS unit 631. As discussed previously, this information may be used to determine where the movable AP 602 (and other movable APs) should be positioned. In some embodiments, the information provided by the GPS unit 631 may be sent to other devices, such as one or more network controllers.

As discussed above, a movable AP 602 may include an AP that is mounted or otherwise attached to a vehicle, which may be a ground vehicle or an aerial vehicle. In some embodiments, a movable AP 602 may include a vehicle controller 633 that controls the operation of the vehicle. When a determination is made that the movable AP 602 should be repositioned, the vehicle controller 633 may activate one or more vehicle components in order to cause the movable AP 602 to be repositioned.

The various components of the movable AP 602 may be coupled together by one or more buses, which may include a power bus, a control signal bus, a status signal bus, a data bus, etc. For the sake of clarity, the various buses are illustrated in FIG. 6 as a bus system 619.

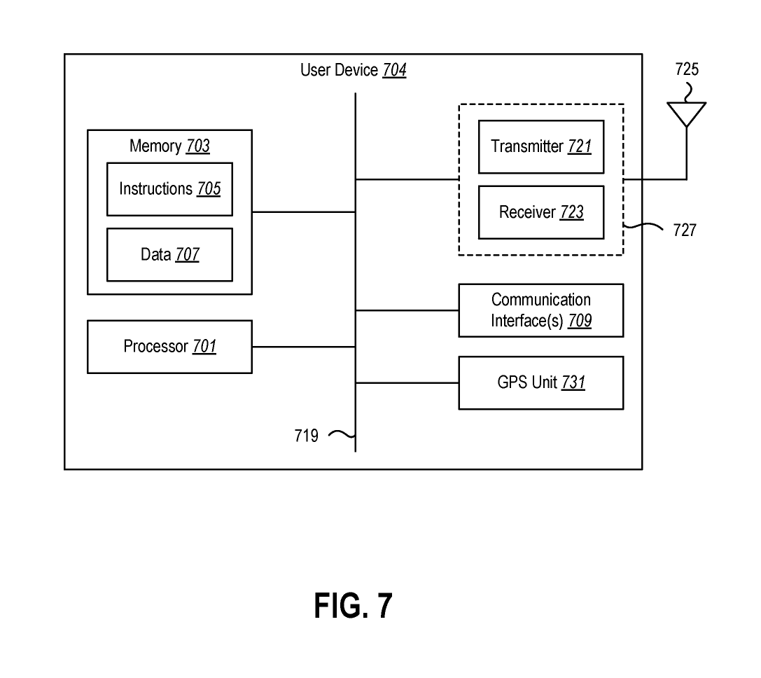

FIG. 7 illustrates certain components that may be included in a user device 704. Any of the user devices 104a-f, 204, 304a-h, 404a-h described herein may be implemented with some or all of the components shown in the user device 704.

The user device 704 may include a processor 701, memory 703, instructions 705 and data 707 stored in the memory 703, a transceiver 727 (including a transmitter 721, a receiver 723, and an antenna 725), one or more other communication interfaces 709, and a GPS unit 731. The various components of the user device 704 may be coupled together by a bus system 719. These components may be similar to the corresponding components described above in connection with the movable AP 602.

The instructions 705 may be executable by the processor 701 to implement some or all of the functionality that has been described herein with respect to the user devices 104a-f, 204, 304a-h, 404a-h. For example, the instructions 705 may be executable by the processor 701 to determine the sphere of error associated with the user device 704 and to report sphere of error information 108 (and possibly other information as well, such as location information 106) to an AP. Some examples of data 707 that may be stored in the memory 703 and used in connection with executing the instructions 705 include location information 106, sphere of error information 108, an acceptable threshold for the sphere of error, user priority information 110, and application information 112.

The transceiver 727 may enable the user device 704 to transmit information (e.g., location information 106, sphere of error information 108) to APs. The GPS unit 731 may be configured to determine information about the current location of the user device 704. The location information 106 discussed previously may include information provided by the GPS unit 731. As discussed previously, the user device 704 may report location information 106 to an AP, and the location information 106 may be used to determine where one or more movable APs within a network should be positioned.

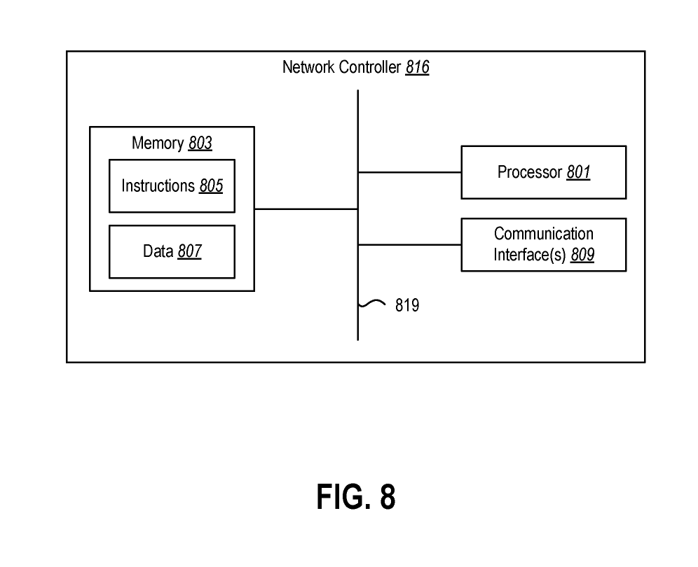

FIG. 8 illustrates certain components that may be included in a network controller 816. Any of the network controllers 316, 416a-b described herein may be implemented with some or all of the components shown in the network controller 816.

The network controller 816 may include a processor 801, memory 803, instructions 805 and data 807 stored in the memory 803, and one or more communication interfaces 809. The various components of the network controller 816 may be coupled together by a bus system 819. These components may be similar to the corresponding components described above in connection with the movable AP 602.

The instructions 805 may be executable by the processor 801 to implement some or all of the functionality that has been described herein with respect to the network controllers 316, 416a-b. For example, the instructions 805 may be executable by the processor 801 to perform some or all of the operations described above in connection with the method 500 shown in FIG. 5. Some examples of data 807 that may be stored in the memory 803 and used in connection with executing the instructions 805 include location information 106, sphere of error information 108, user priority information 110, application information 112, information describing one or more desired outcomes for a network, and repositioning instructions (which may, for example, be sent to one or more movable APs).

A method for managing variable traffic load in a wireless network is disclosed. The method includes determining relative location information corresponding to user devices and at least one movable access point in the wireless network. The method also includes determining sphere of error information corresponding to the user devices. The method also includes determining, based at least in part on the relative location information and the sphere of error information, that the at least one movable access point should be repositioned to achieve a desired outcome. The method also includes causing the at least one movable access point to be repositioned.

In some embodiments, determining that the at least one movable access point should be repositioned may comprise determining that the at least one movable access point should be moved from a current location to a new location. Alternatively, determining that the at least one movable access point should be repositioned may comprise determining that an antenna of the at least one movable access point should be reoriented.

The desired outcome may comprise equalizing spheres of error across the user devices within the wireless network. Alternatively, the desired outcome may comprise minimizing spheres of error for one or more high priority user devices within the wireless network.

In some embodiments, determining that the at least one movable access point should be repositioned may additionally be based on at least one of user priority information and application information.

The method may be performed by a movable access point. Alternatively, the method may be performed by a network controller that is distinct from the at least one movable access point.

In some embodiments, causing the at least one movable access point to be repositioned may comprise sending instructions to the at least one movable access point.

The sphere of error information may be determined using a Hamming distance as a radius of a sphere of error. Alternatively, the sphere of error information may be determined using a Euclidean distance as a radius of a sphere of error.

In some embodiments, determining that the at least one movable access point should be repositioned may be based at least in part on determining that a sphere of error for one or more user devices has exceeded a defined threshold for a certain time period.

A system for managing variable traffic load in a wireless network is also disclosed. The system includes one or more processors and memory comprising instructions that are executable by the one or more processors to perform certain operations. The operations may include determining relative location information corresponding to user devices and at least one movable access point in the wireless network. The operations may also include determining sphere of error information corresponding to the user devices. The operations may also include determining, based at least in part on the relative location information and the sphere of error information, that the at least one movable access point should be repositioned to achieve a desired outcome. The operations may also include causing the at least one movable access point to be repositioned.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for managing variable traffic load in a wireless network, comprising:
determining relative location information corresponding to user devices and at least one movable access point in the wireless network;
determining sphere of error information corresponding to the user devices;
determining, based at least in part on the relative location information and the sphere of error information, that the at least one movable access point should be repositioned to achieve a desired outcome; and
causing the at least one movable access point to be repositioned.

2. The method of claim 1, wherein determining that the at least one movable access point should be repositioned comprises determining that the at least one movable access point should be moved from a current location to a new location.

3. The method of claim 1, wherein determining that the at least one movable access point should be repositioned comprises determining that an antenna of the at least one movable access point should be reoriented.

4. The method of claim 1, wherein the desired outcome comprises equalizing spheres of error across the user devices within the wireless network.

5. The method of claim 1, wherein the desired outcome comprises minimizing spheres of error for one or more high priority user devices within the wireless network.

6. The method of claim 1, wherein determining that the at least one movable access point should be repositioned is additionally based on at least one of user priority information and application information.

7. The method of claim 1, wherein the method is performed by a movable access point.

8. The method of claim 1, wherein the method is performed by a network controller that is distinct from the at least one movable access point.

9. The method of claim 1, wherein causing the at least one movable access point to be repositioned comprises sending instructions to the at least one movable access point.

10. The method of claim 1, wherein the sphere of error information is determined using a Hamming distance as a radius of a sphere of error.

11. The method of claim 1, wherein the sphere of error information is determined using a Euclidean distance as a radius of a sphere of error.

12. The method of claim 1, wherein determining that the at least one movable access point should be repositioned is based at least in part on determining that a sphere of error for one or more user devices has exceeded a defined threshold for a certain time period.

13. A system for managing variable traffic load in a wireless network, comprising:
one or more processors; and
memory comprising instructions that are executable by the one or more processors to perform operations comprising:
determining relative location information corresponding to user devices and at least one movable access point in the wireless network;
determining sphere of error information corresponding to the user devices;
determining, based at least in part on the relative location information and the sphere of error information, that the at least one movable access point should be repositioned to achieve a desired outcome; and
causing the at least one movable access point to be repositioned.

14. The system of claim 13, wherein determining that the at least one movable access point should be repositioned comprises determining that the at least one movable access point should be moved from a current location to a new location.

15. The system of claim 13, wherein determining that the at least one movable access point should be repositioned comprises determining that the at least one movable access point should be reoriented.

16. The system of claim 13, wherein the desired outcome comprises equalizing spheres of error across the user devices within the wireless network.

17. The system of claim 13, wherein the desired outcome comprises minimizing spheres of error for one or more high priority user devices within the wireless network.

18. The system of claim 13, wherein determining that the at least one movable access point should be repositioned is additionally based on at least one of user priority information and application information.

19. The system of claim 13, wherein the operations are performed by a movable access point.

20. The system of claim 13, wherein the operations are performed by a network controller that is distinct from the at least one movable access point.
